(19) United States
(12) Patent Application Publication
(10) Pub. No.: US 2024/0242303 A1
(43) Pub. Date: Jul. 18, 2024

(54) TOOL DIFFERENTIATOR BETWEEN FRAUD AND STRUGGLING CUSTOMERS IN REAL TIME

(71) Applicant: Bank of America Corporation, Charlotte, NC (US)

(72) Inventors: Doan T. Tran, Santa Clarita, CA (US); Michael A. Testa, Scituate, RI (US)

(21) Appl. No.: 18/097,606

(22) Filed: Jan. 17, 2023

(51) Int. Cl. G06Q 50/26; G06Q 40/02; H04M 3/436; H04M 3/51

(52) U.S. Cl. CPC G06Q 50/265; G06Q 40/02; H04M 3/436; H04M 3/51

(57) ABSTRACT

Systems and methods for detecting fraud when receiving multiple calls from a caller to an enterprise's call center. Methods may include using a computer processor to determine if the caller's automatic number identification (ANI) is associated with more than five calls received by the call center within a current calendar day. If so, methods may include using a computer processor to determine the following parameters. The incoming calls from the ANI inquired about more than five customer accounts. The call refers to a customer account that has received multiple calls per month for less than four out of the last twelve months. The ANI of the incoming call is different from any phone numbers associated with the customer account. The response measure may be a fraud prevention response measure when one or more of the parameters are true, or a customer service response measure when none are true.

### FIELD OF TECHNOLOGY

Aspects of the disclosure relate to apparatus and methods for detecting fraud at call centers. Aspects of the disclosure relate to apparatus and methods for addressing repeat callers.

### BACKGROUND OF THE DISCLOSURE

Enterprise call centers receive large volumes of calls each day spread over many customer service agents as well as over an interactive voice response (IRV) system. This large volume provides callers with malicious intent an opportunity to perform and benefit from fraud as their efforts may be hard to detect due to the large volume of calls. This large volume can also lead to frustration among genuine customers who reach out to the call center to resolve an issue. Failing to address fraud may cause an enterprise and their customers to lose money and time. Failing to address the needs of genuine customers may cause dissatisfaction among a customer base which may lead to a loss of the customer's business.

There is a need for systems and methods to effectively handle incoming calls to an enterprise's call center where the caller's intentions vary.

There is a need for systems and methods to effectively address malicious calls made to a call center to avoid losses to the enterprise and its customers.

There is a need for systems and methods to effectively handle the needs of genuine customers to ensure that customers have a positive experience with the call center by resolving their issues in a timely manner.

There is a need to look retrospectively to identify previously committed fraud.

### SUMMARY OF THE DISCLOSURE

Provided are systems and methods for effectively handling incoming calls to an enterprise's call center where the caller's intentions vary. Further provided are systems and methods for handling calls to the call center in real time to avoid the calls getting elevated in the call center management structure.

Provided are systems and methods for effectively addressing malicious calls made to a call center to avoid losses to the enterprise and its customers. Further provided are systems and methods to handle calls with malicious intent in real time to minimize losses.

Provided are systems and methods for efficiently handling the needs of genuine customers to ensure they have a positive experience with the call center. Further provided are systems and methods to handle the needs of a genuine customer in real time to enhance their satisfaction with the enterprise's goods and services.

Provided are systems and methods for identifying current fraud and looking back retrospectively to identify previously committed fraud by a similar party.

Apparatus and methods are herein provided to meet the above outlined objectives of the invention. Aspects of the disclosure may relate to an apparatus and method for determining in real time an intent of a caller to an enterprise's call center. The intent may be malicious where the caller seeks to perform fraud. Alternatively, the intent may be that of a genuine customer seeking some sort of assistance.

Methods may include addressing a repeat caller to an enterprise's call center. Methods may include using a computer processor to determine if an automatic number identification (ANI) correlating to an incoming call to the call center is associated with more than five calls received by the call center within a current calendar day. Methods may include using a computer processor to determine if one or more of the following parameters are true. The parameters may include using a computer processor to determine if an intent of an incoming call is associated with a possibility of fraud. The parameters may include using a computer processor to determine if an authorization method provided by the incoming call is a weak authorization method. Parameters may include using a computer processor to determine if a fraud alert has been generated in the last twelve months in association with the ANI or the customer account identified during the incoming call. Parameters may include using a computer processor to determine if a failed authorization attempt in the last twelve months is associated with the ANI of the incoming call or the customer account identified during the incoming call. Parameters may include using a computer processor to determine if the ANI of the incoming call is different from any phone numbers associated with the customer account identified during the incoming call.

Methods may include using a computer processor to initiate a response measure when the ANI related to the incoming call to the call center is associated with more than five calls received by the call center within the current calendar day. The response measure may be a fraud prevention response measure when at least two of the previously mentioned parameters are true. The response measure may be a customer service response measure when less than two of the parameters are true. The intent associated with the possibility of fraud may be a reporting of a damaged credit card or a request to change an address associated with the customer account identified during the incoming call. The weak authorization method may include providing a postal code.

Methods may include generation of the fraud prevention response measure during the incoming call. Methods may include initiation of the fraud prevention response measure within the calendar day of receiving the incoming call.

Methods may include initiation of the customer service response measure during the incoming call. Methods may include initiation of the customer service response measure within the calendar day of receiving the incoming call.

Methods may include where the fraud prevention response measure is to cancel a credit card associated with the customer account and reissue a new credit card to an address associated with the customer account. Methods may include where the fraud prevention response measure is to transmit a notification containing a fraud alert against the ANI, the customer account, or both the ANI and customer account to an organization which is administering the call center.

Methods may include where the customer service response measure is to transfer the incoming call into a queue to speak with a customer service representative. Methods may include where the customer service response measure is to transfer the incoming call into a higher position in a queue to speak with a customer service representative than the incoming call would have received otherwise.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative block diagram in accordance with principles of the disclosure;

FIG. 2 shows an illustrative block diagram in accordance with principles of the disclosure;

FIG. 3 shows an illustrative pie chart in accordance with principles of the disclosure;

FIG. 4 shows an illustrative pie chart in accordance with principles of the disclosure;

FIG. 5 shows illustrative tables in accordance with principles of the disclosure;

FIG. 6 shows illustrative tables in accordance with principles of the disclosure;

FIG. 7 shows an illustrative figure and tables in accordance with principles of the disclosure;

FIG. 8 shows an illustrative figure and tables in accordance with principles of the disclosure;

FIG. 9 shows an illustrative flowchart of a process in accordance with principles of the disclosure;

FIG. 10 shows an illustrative flowchart of a process in accordance with principles of the disclosure; and

FIG. 11 shows an illustrative flowchart of a process in accordance with principles of the disclosure.

### DETAILED DESCRIPTION OF THE DISCLOSURE

Aspects of the disclosure may relate to an apparatus and method for determining in real time an intent of a caller to an enterprise's call center. The intent may be malicious where the caller seeks to perform fraud. The intent may be that of a genuine customer seeking some sort of assistance.

Methods may include detecting fraud when receiving multiple calls from a caller to an enterprise's call center. Methods may include using a computer processor to determine if an automatic number identification (ANI) correlating to an incoming call to the call center is associated with a certain number of calls received by the call center within a current calendar day. ANI facilitates the capture and display of a caller's phone number for a call recipient. The number of calls received may be more than three. The number of calls received may be more than five. The number of calls received may be more than ten. The number of calls received may be more than twenty. Another number of calls may also be feasible.

Methods may include using a computer processor to determine if one or more of the following parameters are true.

The parameters may include using a computer processor to determine if the more than five calls received by the call center within the current calendar day from the ANI inquired about an account of more than one customer. The calls received may have inquired about an account of more than two customers. The calls received may have inquired about an account of more than three customers. The calls received may have inquired about an account of more than four customers. The calls received may have inquired about an account of more than five customers. The calls received may have inquired about an account of more than ten customers. The calls received may have inquired about an account of more than twenty customers. Other numbers of multiple accounts inquired about by ANI associated with the incoming call are feasible. The multiple accounts may include multiple accounts to a single customer. Alternatively, the accounts may include accounts of distinct customers. The accounts may include a combination of accounts for a single customer and accounts of distinct customers.

The parameters may include using a computer processor to determine if multiple calls per month to the call center relating to a customer account identified during the incoming call have been received infrequently. Without a history of multiple calls per month, a sudden uptick in calls from a single ANI may indicate an attempt to perform fraud. An infrequent history of multiple calls per month may be less than six months of multiple calls to the call center over the past twelve months. An infrequent history may be less than five months of multiple calls to the call center over the past twelve months. An infrequent history may be less than four months of multiple calls to the call center over the past twelve months. An infrequent history may be less than three months of multiple calls to the call center over the past twelve months. An infrequent history may be less than two months of multiple calls to the call center over the past twelve months.

The parameters may include using a computer processor to determine if an intent of an incoming call is associated with a possibility of fraud. For example, an intent that may be associated with the possibility of fraud is reporting a damaged credit card. In this case, the caller may seek to complete a transaction by bypassing the presence of an actual usable credit card. In this case, the caller may not actually possess the credit card, or may possess cutup remains of the credit card. Another example of an intent that may be associated with the possibility of fraud may be that of a caller requesting to change an address associated with the customer account identified during the incoming call. The caller may seek, for example, to change the address from the genuine customer to an address the caller controls. Other examples of intents that may be associated with the possibility of fraud are feasible.

Examples of a caller's intent that may be associated with a genuine customer in need includes a request to speak to an agent. Another example may be to address issues encountered during online banking. Other genuine customer needs may be feasible.

The parameters may include using a computer processor to determine if an authorization method provided by the incoming call is a weak authorization method. For example, the caller may present the account number. The caller may have obtained the account number from any of many possibilities. For example, the caller may have found a communication in the trash of the customer with an account number on it. Alternatively, the caller may have taken mail from the mailbox of the customer. Many other possibilities may be feasible.

Parameters may include using a computer processor to determine if a fraud alert has been generated in association with the ANI. Parameters may include using a computer processor to determine if a fraud alert has been generated in association with the customer's account identified during the incoming call. A window of time for looking back for the fraud alert, either in association with the ANI or in associate with the customer's account identified during the incoming call, may be the past week. The window of time may be the past month. The window of time may be the past three months. The window of time may be the twelve months. Any other window of time may also be feasible.

Parameters may include using a computer processor to determine if one or more failed authorization attempts are associated with the ANI of the incoming call. Parameters may include using a computer processor to determine if one or more failed authorization attempts are associated with the customer account identified during the incoming call. The one or more failed authorization attempts may have been over the past calendar day. The one or more failed authorization attempts may have been over the past week. The one or more failed authorization attempts may have been over the past month. The one or more failed authorization attempts may have been over the past three months. The one or more failed authorization attempts may have been over the past twelve months. In one aspect, the number of failed authorization attempts may be two or more. In another aspect, the number of failed authorization attempts may be three or more. In a further aspect, the number of failed authorization attempts may be four or more. The number of failed authorization attempts may be five or more. Any other window of time may also be feasible. Any other number of authorization attempts may also be feasible.

Parameters may include using a computer processor to determine if the ANI of the incoming call is different from any phone numbers associated with the customer account identified during the incoming call.

Methods may include using a computer processor to initiate a response measure when the ANI related to the incoming call to the call center is associated with more than a threshold number of calls received by the call center within the current calendar day. The threshold may be more than three calls. The threshold may be more than five calls. The threshold may be more than ten calls. The threshold may be more than twenty calls. Another number of calls may also be feasible.

When the call center receives more than a threshold number of calls from one ANI within one calendar day, the enterprise running the call center may want to gain insight into the cause for the high volume of calls. The enterprise may want to assess if the calls originated from a malicious attempt by a party to commit fraud against the enterprise. The enterprise may want to assess if the calls originated from a distressed customer who needs some form of enhanced customer service. A high volume of calls to a call center from a single ANI within a single calendar day may require a response measure, regardless of intent.

The previous list of parameters may assist an enterprise in determining an intend of the caller associated with the ANI. Positive answers to the parameters may indicate a higher likelihood of fraudulent intent. Negative answers to the parameters may indicate a genuine customer in need of assistance. When monitoring multiple parameters, the more parameters that are answered in the positive may indicate a higher likelihood of a fraudulent intent of the caller. The more parameters answered in the negative may indicate a higher likelihood of a genuine need for help from the caller.

Monitoring various numbers of parameters may help determine a caller's intents. For example, when the list of parameters contains one, two, three, or four parameters, the threshold of parameters indicating a fraudulent intent may be one. Less than one may indicate that the caller is a genuine customer needing assistance. When the list of parameters contains two, three, four, five, or six parameters, the threshold of parameters indicating a fraudulent intent may be two. Less than two may indicate that the caller is a genuine customer needing assistance. When the list of parameters contains three, four, five, six, seven, eight, nine, or ten parameters, the threshold of parameters indicating a fraudulent intent may be three. Less than three may indicate that the caller is a genuine customer needing assistance. When the list of parameters contains four, five, six, seven, eight, nine, ten, eleven, or twelve parameters, the threshold of parameters indicating a fraudulent intent may be four. Less than four may indicate that the caller is a genuine customer needing assistance.

Detecting a repeat caller's intent may be nuanced. In addition, or alternatively to a binary determination of a parameter, the computer processor may assign a score to a parameter. The computer processor may use a scale where a caller with fraudulent intent may be represented as being at one end and a distressed customer may be represented as being at the other end. One parameter may have a stronger correlation to fraudulent activity than another, even though both may be indicative of potentially fraudulent activity. The computer processor may assign each parameter with a certain weighting. The computer processor may monitor incoming calls from a repeat caller for the caller's intent by monitoring various numbers of parameters. The parameters may be positively correlated with fraudulent activity or negatively correlated with fraudulent activity. The latter case may indicate a genuine customer in need of enhanced customer service. When making an overall determination of the caller's intent, the computer processor may determine an overall scoring based on the measurement of the parameters received and each parameter's relative weighting.

When the overall scoring is above a certain threshold value, the result may indicate a high probability of fraudulent intent on the part of the caller. When the overall scoring is below a certain threshold value, the result may indicate a lower probability of fraudulent intent on the part of the caller. In the latter case, the result may indicate a higher probability of a genuine customer in need of assistance. The two threshold values just mentioned may be the same threshold. The two threshold values just mentioned may be different thresholds. When a threshold value is crossed, the computer processor may initiate a real time response. The computer processor may initiate a fraud prevention response measure. Alternatively, the computer processor may initiate a customer service response measure.

The computer processor may use an artificial intelligence (AI) model to modify the weighting of each parameter over time. The computer processor may use a machine learning model to teach the AI model. The computer processor may use a neural network model to teach the AI model.

When the intent may be a fraudulent intent, for example, when reaching the threshold of parameters, the response measure may be a fraud prevention response measure.

Methods may include initiating the fraud prevention response measure during the incoming call. Methods may include initiating the fraud prevention response measure within the same calendar day as receipt of the incoming call. Methods may include initiating the fraud prevention response measure within twenty-four hours following completion of the incoming call.

Methods may include where the fraud prevention response measure is to cancel a credit card associated with the customer account and reissue a new credit card to an address associated with the customer account. Methods may include where the fraud prevention response measure is to transmit a notification containing a fraud alert against the ANI, the customer account, or both the ANI and customer account to an organization which is administering the call center. Methods may include where the fraud prevention response measure is to cancel a credit card associated with one or more customer accounts associated with the other customer account. Methods may include where the fraud prevention response measure is to transmit a notification containing a fraud alert against the other customer accounts.

When not reaching the threshold, the intent may be a customer service intent and the response measure may be a customer service response measure.

Methods may include initiating the customer service response measure during the incoming call. Methods may include initiating the customer service response measure within the same calendar day as receipt of the incoming call. Methods may include initiating the customer service response measure within twenty-four hours following completion of the incoming call.

Methods may include where the customer service response measure is to transfer the incoming call into a queue to speak with a customer service representative. Methods may include where the customer service response measure is to transfer the incoming call into a higher position in a queue to speak with a customer service representative than the incoming call would have received had the customer service response measure not been initiated.

Apparatus and methods described herein are illustrative. Apparatus and methods in accordance with this disclosure are now described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

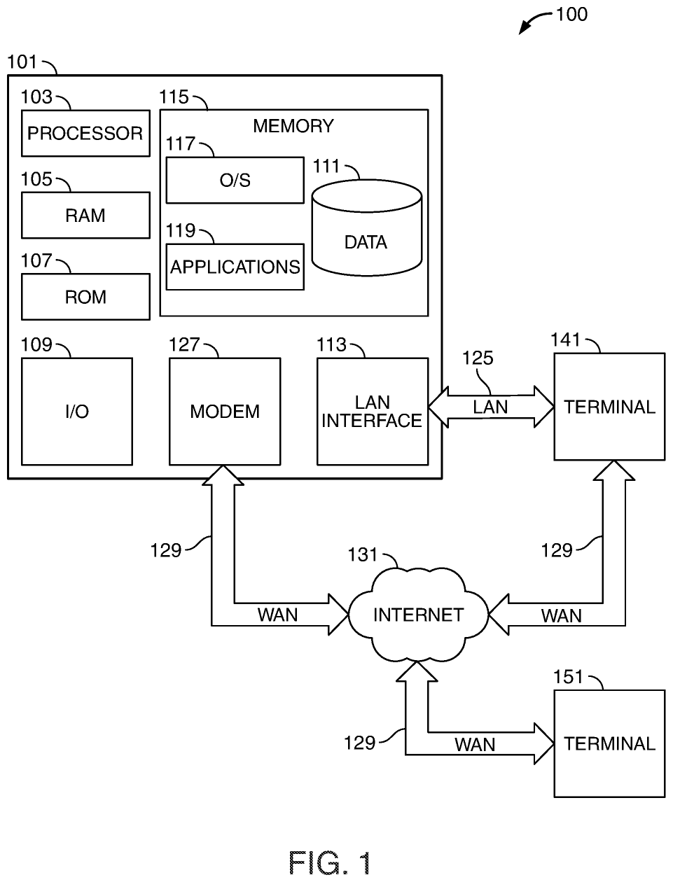

FIG. 1 shows an illustrative block diagram of system 100 that includes computer 101. One may refer to Computer 101 as an “engine,” “server” or “computing device.” Computer 101 may be a workstation, desktop, laptop, tablet, smart phone, or any other suitable computing device. One may use elements of system 100, including computer 101, to implement various aspects of the systems and methods disclosed herein.

Computer 101 may have processor 103 for controlling operation of the device and its associated components, and may include RAM 105, ROM 107, input/output module 109, and non-transitory/non-volatile machine-readable/writeable memory 115. One may configure machine-readable/writeable memory to store information in machine-readable/writeable data structures. Processor 103 may also execute all software running on the computer—e.g., an operating system and/or voice recognition software. Other components commonly used for computers, such as EEPROM or Flash memory or any other suitable components, may also be part of computer 101.

Memory 115 may be comprised of any suitable permanent storage technology—e.g., a hard drive. Memory 115 may store software including operating system 117 and application program(s) 119 along with any data 111 needed for operation of system 100. Memory 115 may also store videos, text, and/or audio assistance files. One may store data in memory 115, in cache memory, or in any other suitable memory.

Input/output (“I/O”) module 109 may include connectivity to a microphone, keyboard, touch screen, mouse, and/or stylus. One may provide input into computer 101 through these I/O modules. The input may include input relating to cursor movement. I/O 109 may also include one or more speakers for providing audio output and a video display device for providing textual, audio, audiovisual, and/or graphical output. The input and/or output may be related to computer application functionality.

One may connect System 100 to other systems via local area network (LAN) interface (or adapter) 113. System 100 may operate in a networked environment supporting connections to one or more remote computers, such as terminals 141 and 151. Terminals 141 and 151 may be personal computers or servers that include many or all the elements described above relative to system 100. Network connections depicted in FIG. 1 include a local area network (LAN) 125 and a wide area network (WAN) 129 but may also include other networks. One may connect computer 101 to LAN 125 through LAN interface (or adapter) 113 when using a LAN networking environment. When used in a WAN networking environment, computer 101 may include modem 127 or other means for establishing communications over WAN 129, such as Internet 131.

One appreciates that the network connections shown are illustrative. One may use other means of establishing a communications link between computers. One may presume the existence of various well-known protocols such as TCP/IP, Ethernet, FTP, HTTP, and the like. One may operate the system in a client-server configuration to permit retrieval of data from a web-based server or application programming interface (API). One may understand that web-based, for this application, includes a cloud-based system. The web-based server may transmit data to any other suitable computer system. The web-based server may also send computer-readable instructions, together with data, to any suitable computer system. The computer-readable instructions may be to store data in cache memory, the hard drive, secondary memory, or any other suitable memory.

Additionally, one may use application program(s) 119 on computer 101. These programs may include computer executable instructions for invoking functionality related to communication, such as e-mail, Short Message Service (SMS), and voice input and speech recognition applications. One may refer to application program(s) 119 (alternatively, “plugins,” “applications,” or “apps”) to include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for the processing of calls received from calling sources as detailed herein.

Application program(s) 119 may include computer executable instructions (alternatively referred to as “programs”). Embodied in hardware or firmware (not shown) may be the computer executable instructions. Computer 101 may execute the instructions embodied by the application program(s) 119 to perform various functions.

Application program(s) 119 may utilize the computer-executable instructions executed by a processor. Programs include routines, programs, objects, components, data structures, etc. that perform tasks or implement abstract data types. A computing system may be operational with distributed computing environments. Remote processing may perform tasks on devices linked through a communications network. In a distributed computing environment, a program may be in both local and remote computer storage media including memory storage devices. Computing systems may rely on a network of remote servers hosted on the Internet to store, manage, and process data (e.g., “cloud computing” and/or “fog computing”).

Stored in memory 115 is any information described above in connection with database 111, and any other suitable information. One or more of application program(s) 119 may include one or more algorithms used to add data and metadata to a database, identify a type of form being used, predict fields in a document, identify changes between documents, provide changes to an entity to ascertain if an error is present, identify fraud concerns, communicate fraud concerns to interested parties within an organization, and provide documents for providing to a regulatory authority.

One may describe the invention in the context of computer-executable instructions, such as application program(s) 119, for execution by a computer. Programs may include routines, programs, objects, components, and data structures, which perform tasks or implement data types. One may practice the invention in distributed computing environments. One may perform tasks by remote processing devices, linked through a communications network. In a distributed computing environment, programs may be in both local and remote computer storage media including memory storage devices. One may consider such programs, for this application's purposes, as engines for the performance of the program-assigned tasks.

Computer 101 and/or terminals 141 and 151 may also include various other components, such as a battery, speaker, and/or antennas (not shown). One may link components of computer system 101 by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

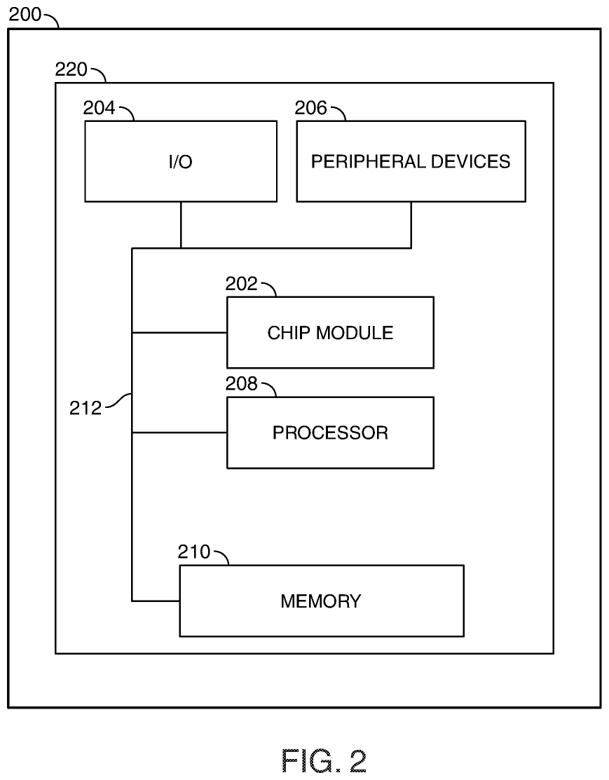

FIG. 2 shows an illustrative block diagram of apparatus 200. One may configure apparatus 200 in accordance with the principles of the disclosure. Apparatus 200 may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real time timers, power-on reset generators or any other suitable peripheral devices; logical processing device 208, which may compute data structural information and structural parameters of data; and machine-readable/writeable memory 210.

One may configure machine-readable/writeable memory 210 to store information in machine-readable/writeable data structures, such as: machine executable instructions (for example, “computer instructions” or “computer code”); applications, signals; and/or any other suitable information or data structures.

One may couple together components 202, 204, 206, 208 and 210 by system bus (or other interconnections) 212 and may be present on one or more than one circuit board 220. In some embodiments, the components may be integrated into a single chip. The chip may be silicon-based.

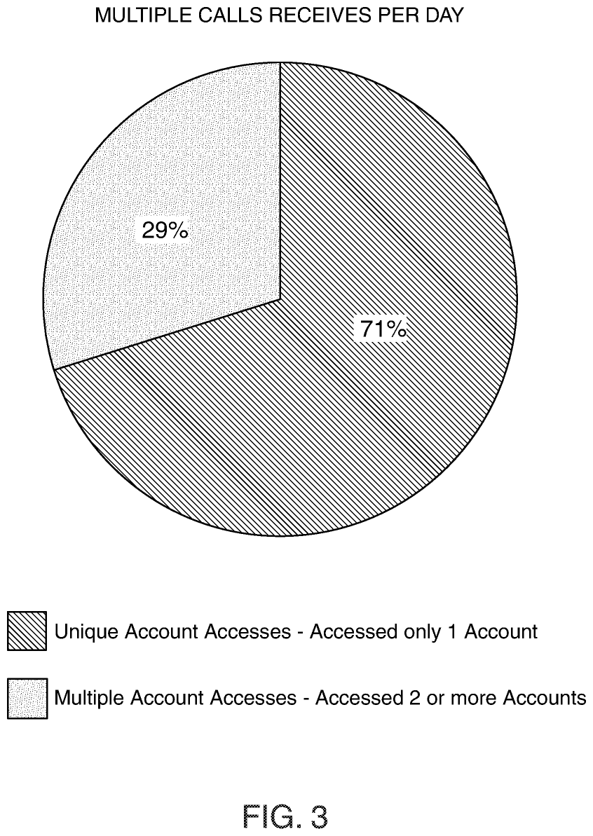

FIG. 3 shows an illustrative pie chart 300. Represented on the pie chart may be multiple call received by a caller center per day, on average. For example, multiple calls may be more than five calls received at a calling center from one ANI. 71% of instances of receiving more than five calls from a single ANI, the caller accessed a unique account. 29% of instances of receiving more than five calls from a single ANI, the caller accessed multiple accounts, for example, two or more accounts.

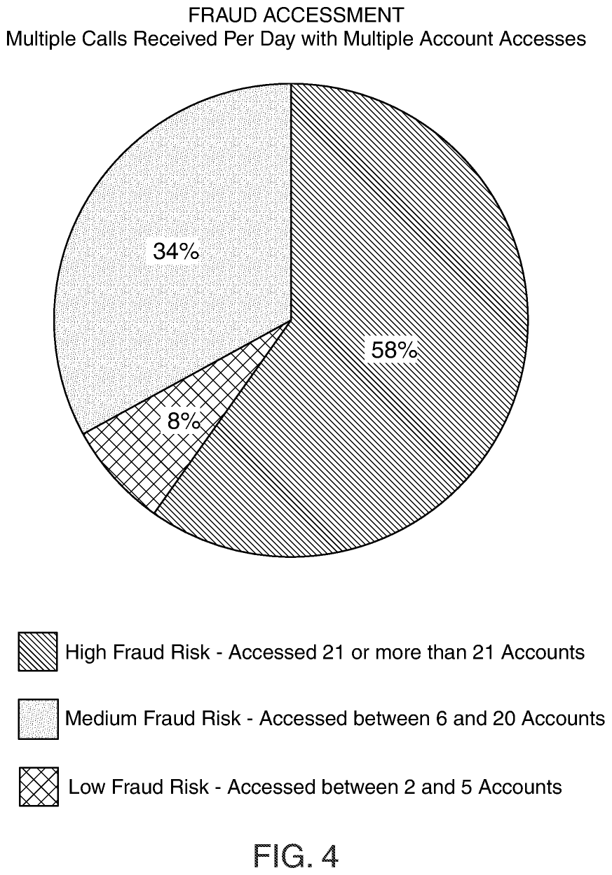

FIG. 4 shows an illustrative pie chart 400. Represented on the pie chart may be a fraud assessment. The data used for this pie chart may be multiple calls received by a call center, such as more than five calls per calendar day, where the caller accessed multiple accounts of one or more customers. For example, in pie chart 300 of FIG. 3, 29% of instances of more than five calls from a single ANI involved the caller accessed multiple accounts of one or more customers.

In pie chart 400, 34% of the time when receiving more than five calls from one ANI, between two and five accounts were accessed. This may have a low fraud risk. 8% of the time when receiving more than five calls from one ANI, between six and twenty accounts were accessed. This may have a medium fraud risk. 58% of the time when receiving more than five calls from one ANI, twenty-one or more accounts were accessed. This may have a high fraud risk.

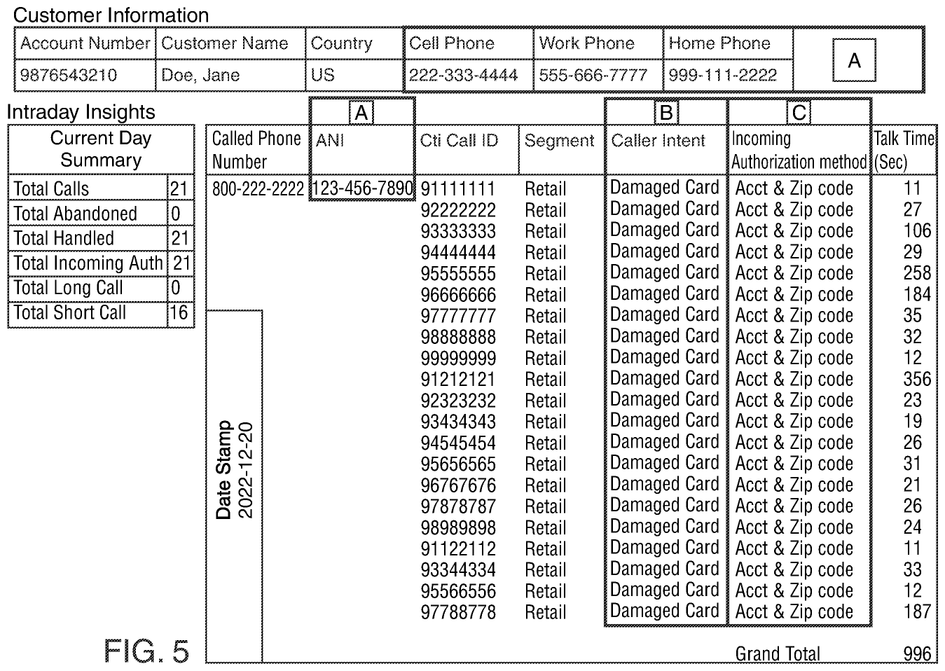

FIG. 5 shows illustrative tables that may serve as a dashboard for a call center representative when receiving an incoming call. In table 500, a customer account number, name, country, cell phone number, work phone number, and home phone number. In table 510, displayed may be a number called to reach a call center, the ANI of the caller, a unique CTi call identification, a segment of the business being inquired about, a caller intent, an incoming authorization method, and a talk time of the call. In table 520, displayed may be a summary of information about a current day's calls from the ANI. The table may include total calls received, total calls abandoned, total calls handled, total incoming calls authorized, total number of long calls, and total number of short calls. A long call designation may be due to a call greater than 600 seconds. A short call designation may be due to a call less than 100 seconds. Other designations for a long call and a short call may be made.

In FIG. 5, there are three types of letter designations, A, B, and C. Each one may provide a parameter for determining if a caller's intent is that of a genuine customer or that of a fraud. The “A” designation may refer to comparing the ANI of the incoming call to a phone number on record for the account number referred to by the caller. The “B” designation may refer to the caller's intent. Examples of a caller's intent include seeking to process a transaction due to a damaged credit card or debit card, a request to speak to a customer service representative, or an inquiry regarding online banking. Other intents of the caller may also be possible. The “C” designation may refer to an incoming authorization method. Examples of incoming authorization methods are account number, zip code, which is also known as a postal code, ANI, and the last four digits of the social security number of the account holder. Other incoming authorization methods may also be possible.

In FIG. 5, for designation “A”, the ANI does not match any of the phone numbers on file for the customer. This may be a sign of fraud. For designation “B”, the caller intent is to seek to process a transaction due to a damaged credit card or debit card. This may be a sign of fraud. For designation “C”, the incoming authorization method is an account number and zip code. These may be a sign of fraud.

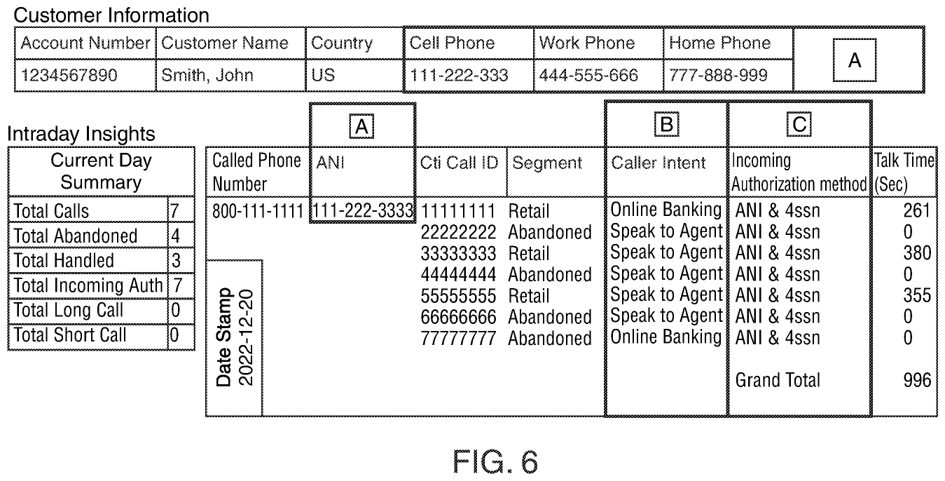

FIG. 6 shows illustrative tables that may serve as a dashboard for a call center representative when receiving an incoming call. As in FIG. 5, FIG. 6 shows three illustrative tables. Table 600 has related categories to table 500 in FIG. 5. Table 610 has related categories to table 510 in FIG. 5. Table 620 has related categories to table 520 in FIG. 5.

FIG. 6 has three types of letter designations, A, B, and C, as in FIG. 6. The “A” designation in FIG. 6 is like the “A” designation in FIG. 5. The “B” designation in FIG. 6 is like the “B” designation in FIG. 5. The “C” designation in FIG. 6 is like the “C” designation in FIG. 5.

In FIG. 6, for designation “A”, the ANI matches the cell phone number on file for the customer. This may be a sign of an authentic customer with a genuine request for assistance. For designation “B”, the caller's intent is either to seek help with online banking or speak to an agent. These may be signs of an authentic customer with a genuine request for assistance. For designation “C”, the incoming authorization method is an ANI and the last four digits of the social security number of the account owner. These may be signs of an authentic customer with a genuine request for assistance.

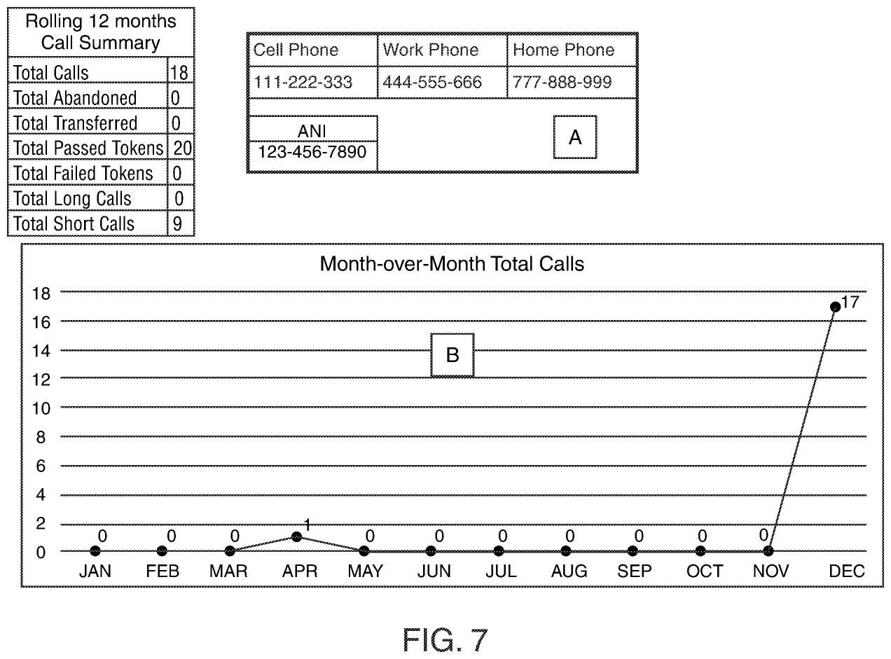

FIG. 7 shows illustrative tables that may supplement the illustrative tables of FIGS. 5 and 6 as further information for a call center representative when receiving an incoming call. FIG. 7 may also serve as an alternative to the dashboard shown in FIGS. 5 and 6. Table 700 may show the ANI of the incoming call and the phone numbers for the customer of record. Table 710 may show a rolling twelve-month call summary. Information included in table 710 may include total calls received, total call abandoned, total calls transferred, total passed tokens, total failed tokens, total long calls, and total short calls. Table 720 may show graphically the number of calls received by the call center for the account number each month for the past twelve months

In FIG. 7, there are two types of letter designations, A and B. Each one may provide a parameter for determining if a caller's intent is that of a genuine customer or that of a fraud. The “A” designation may refer to comparing the ANI of the incoming call to a phone number on record for the account number referred to by the caller. The “B” designation may refer to the month-over-month total of calls per month for the past twelve months. Other intervals of time may also be possible.

In FIG. 7, for designation “A”, the ANI does not match any of the phone numbers on file for the customer. This may be a sign of fraud. For designation “B”, the account owner only called one time before the current month where there are seventeen calls on record. This may be a sign of fraud.

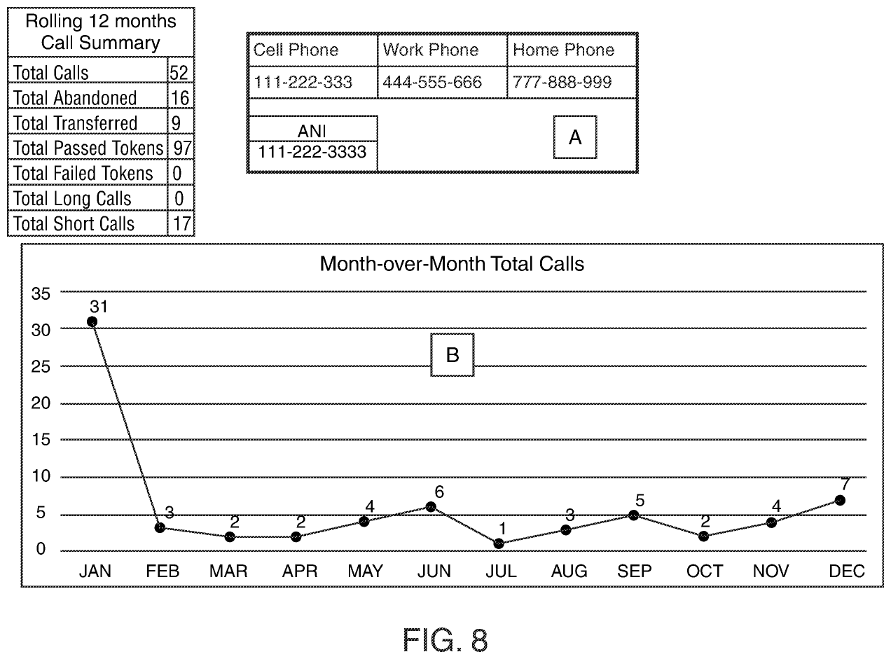

FIG. 8 shows illustrative tables that may supplement the illustrative tables of FIGS. 5 and 6 as further information for a call center representative when receiving an incoming call. FIG. 8 may also serve as an alternative to the dashboard shown in FIGS. 5 and 6. Tables 800, 810, and 820 each correspond to tables 700, 710, and 720 in FIG. 7, except that each table is populated with different data.

As in FIG. 7, in FIG. 8, there are two types of letter designations, A and B. Each one may provide a parameter for determining if a caller's intent is that of a genuine customer or that of a fraud. The “A” designation may refer to comparing the ANI of the incoming call to a phone number on record for the account number referred to by the caller. The “B” designation may refer to the month-over-month total of calls per month for the past twelve months. Other intervals of time may also be possible.

In FIG. 8, for designation “A”, the ANI matches the cell phone number on record for the customer. This may be a sign of fraud. For designation “B”, the account owner frequently called the call center over the past twelve months. In fact, the customer called the call center every month over the past twelve months including multiple calls per month for eleven of the past twelve months. This may be a sign of an authentic customer calling with a genuine request for assistance.

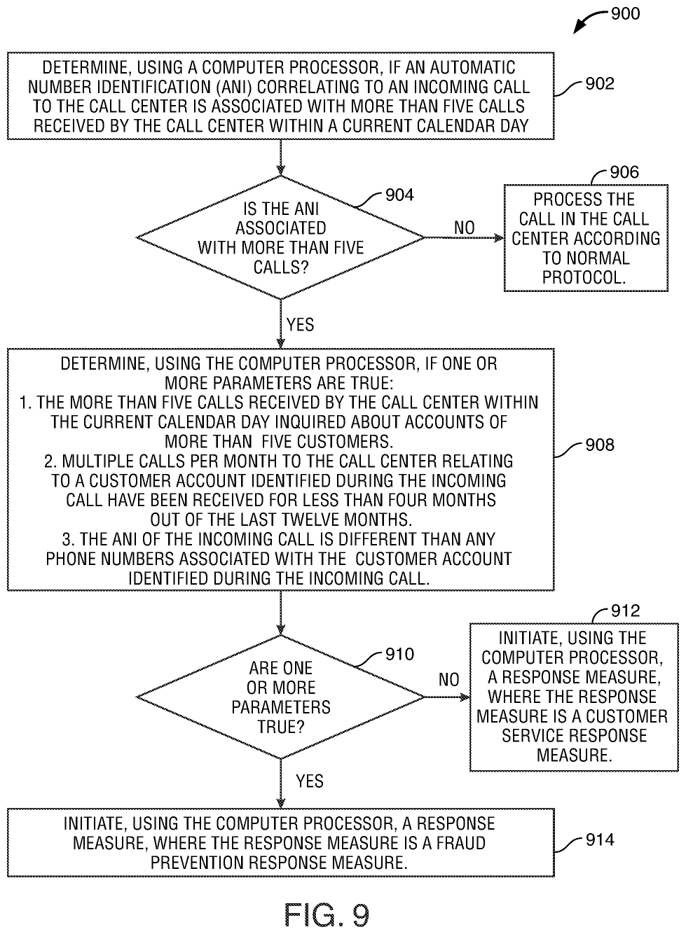

FIG. 9 shows illustrative flow chart 900 of method steps for addressing a repeat caller to an enterprise's call center. Flow chart 900 starts at step 902. At step 902, a computer processor may determine if an ANI correlating to an incoming call to the call center is associated with more than five calls received by the call center within a current calendar day. At step 904, is the ANI associated with more than five calls? If not, then at step 906, the call center processes the call according to its normal protocol. If yes, then at step 908, use a computer processor to determine if one or more of the following parameters are true. Did the more than five calls from the ANI within the current day also inquire about more than five customer accounts? Have multiple calls per month to the call center relating to a customer account identified during the incoming call been received for less than four months out of the last twelve months? Is the ANI of the incoming call different from any phone numbers associated with the customer account identified during the incoming call? At step 910, are one or more parameters true? If not, the computer processor initiates a customer service response measure. If yes, the computer processor initiates a fraud prevention response measure.

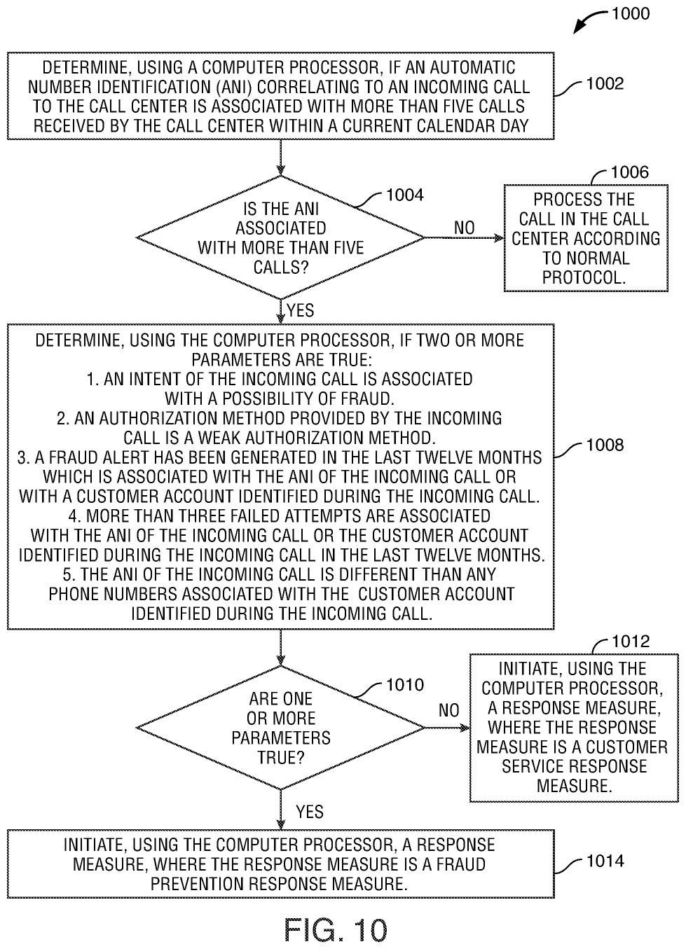

FIG. 10 shows illustrative flow chart 1000 of method steps for addressing a repeat caller to an enterprise's call center.

Flow chart 1000 starts at step 1002. At step 1002, a computer processor may determine if an ANI correlating to an incoming call to the call center is associated with more than five calls received by the call center within a current calendar day. At step 1004, is the ANI associated with more than five calls? If not, then at step 1006, the call center processes the call according to its normal protocol. If yes, then at step 1008, use a computer processor to determine if one or more of the following parameters are true. Is the intent of the incoming call associated with a possibility of fraud? Is an authorization method provided by the incoming call a weak authorization method? Has a fraud alert been generated in the last twelve months which is associated with the ANI of the incoming call or with a customer account identified during the incoming call? Have there been more than three failed authorization attempts associated with the ANI of the incoming call or with the customer account identified during the incoming call in the last twelve months? Is the ANI of the incoming call different from any phone numbers associated with the customer account identified during the incoming call? At step 1010, are two or more parameters true? If not, the computer processor initiates a customer service response measure. If yes, the computer processor initiates a fraud prevention response measure.

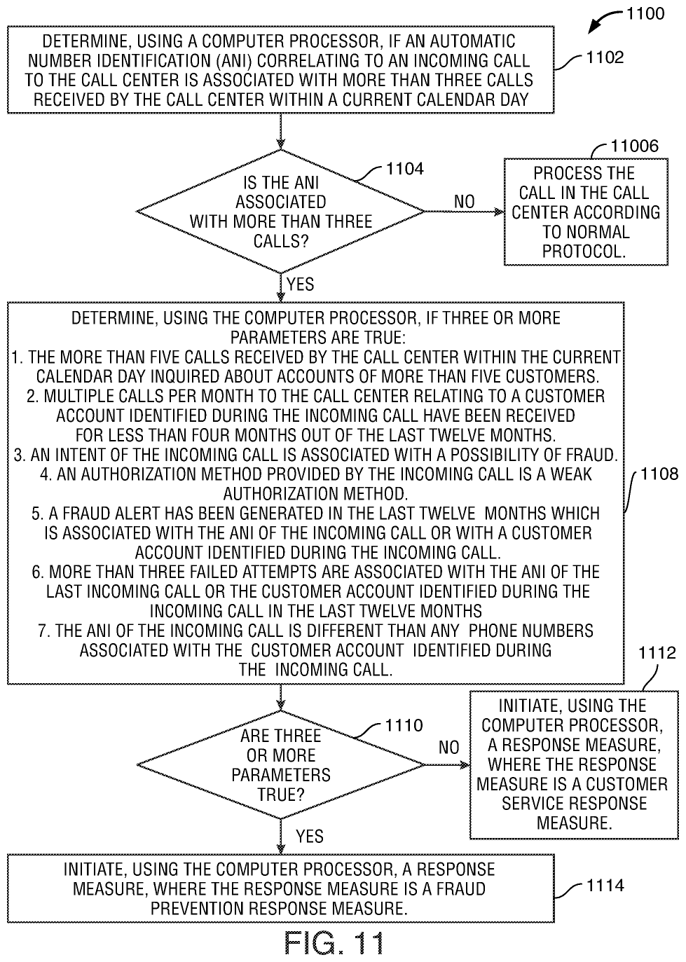

FIG. 11 shows illustrative flow chart 1100 of method steps for detecting fraud when receiving multiple calls from a caller at an enterprise's call center. Flow chart 1100 starts at step 1102. At step 1102, a computer processor may determine if an ANI correlating to an incoming call to the call center is associated with more than five calls received by the call center within a current calendar day. At step 1104, is the ANI associated with more than five calls? If not, then at step 1106, the call center processes the call according to its normal protocol. If yes, then at step 1108, use a computer processor to determine if one or more of the following parameters are true. Did the more than five calls from the ANI within the current day also inquire about accounts of more than five customers? Have multiple calls per month to the call center relating to a customer account identified during the incoming call been received for less than four months out of the last twelve months? Is the intent of the incoming call associated with a possibility of fraud? Is an authorization method provided by the incoming call a weak authorization method? Has a fraud alert been generated in the last twelve months which is associated with the ANI of the incoming call or with a customer account identified during the incoming call? Have there been more than three failed authorization attempts associated with the ANI of the incoming call or with the customer account identified during the incoming call in the last twelve months? Is the ANI of the incoming call different from any phone numbers associated with the customer account identified during the incoming call? At step 1110, are three or more parameters true? If not, the computer processor initiates a customer service response measure. If yes, the computer processor initiates a fraud prevention response measure.

Performance of the steps of methods may be in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for detecting fraud when receiving multiple calls from a caller at an enterprise's call center are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for detecting fraud when receiving multiple calls from a caller to a call center of an enterprise, comprising:
determining, using a computer processor, if an automatic number identification (ANI) correlating to an incoming call to the call center is associated with more than five calls received by the call center within a current calendar day;
determining, using the computer processor, if one or more parameters are true:
the more than five calls received by the call center within the current calendar day inquired about accounts of more than five customers;
multiple calls per month to the call center relating to a customer account identified during the incoming call have been received for less than four months out of the last twelve months; and
the ANI of the incoming call is different from any phone numbers associated with the customer account; and
initiating, using the computer processor, a response measure when the ANI related to the incoming call to the call center is associated with more than five calls received by the call center within the current calendar day;
wherein:
the response measure is a fraud prevention response measure when at least one of the parameters is true;
the response measure is a customer service response measure when none of the parameters are true; and
the response measure is a real time response measure.

2. The method of claim 1, wherein the real time response measure is initiated during the incoming call.

3. The method of claim 1, wherein the real time response measure is initiated within the same calendar day as receipt of the incoming call.

4. The method of claim 1, wherein the fraud prevention response measure is to cancel a credit card associated with the customer account and reissue a new credit card to an address associated with the customer account.

5. The method of claim 1, wherein the fraud prevention response measure is to transmit a notification containing a fraud alert against the ANI, the customer account, or both the ANI and the customer account to an organization which is administering the call center.

6. The method of claim 1, wherein the customer service response measure is to transfer the incoming call into a higher position in a queue to speak with a customer service representative than the incoming call would have received had the customer service response measure not been initiated.

7. The method of claim 1, wherein, when the fraud prevention response measure includes:
determining, using the computer processor, if an account of another customer was accessed by the ANI of the incoming call; and
determining if fraud was committed as a result.

8. A method for addressing a repeat caller to a call center of an enterprise, comprising:
determining, using a computer processor, if an automatic number identification (ANI) correlating to an incoming call to the call center is associated with more than five calls received by the call center within a current calendar day;
determining, using the computer processor, if one or more parameters are true:
an intent of the incoming call is associated with a possibility of fraud;
an authorization method provided by the incoming call is a weak authorization method;
a fraud alert has been generated in the last twelve months which is associated with the ANI of the incoming call or with a customer account identified during the incoming call;
a failed authorization attempt in the last twelve months is associated with the ANI of the incoming call or the customer account; and
the ANI of the incoming call is different from any phone numbers associated with the customer account; and
initiating, using the computer processor, a response measure when the ANI related to the incoming call to the call center is associated with more than five calls received by the call center within the current calendar day;
wherein:
the response measure is a fraud prevention response measure when at least two of the parameters are true;
the response measure is a customer service response measure when less than two of the parameters are true; and
the response measure is provided in real time.

9. The method of claim 8, wherein:
the intent associated with the possibility of fraud is a reporting a damaged credit card or requesting to change an address associated with the customer account; and
the weak authorization method provided is a postal code.

10. The method of claim 8, wherein the real time response measure is initiated during the incoming call

11. The method of claim 8, wherein the real time response measure is initiated within the same calendar day as receipt of the incoming call.

12. The method of claim 8, wherein the fraud prevention response measure is to cancel a credit card associated with the customer account, reissue a new credit card to an address associated with the customer account, and transmit a notification containing a fraud alert against the ANI, the customer account, or both the ANI and the customer account to an organization which is administering the call center.

13. The method of claim 8, wherein the customer service response measure is to transfer the incoming call into a higher position in a queue to speak with a customer service representative than the incoming call would have received had the customer service response measure not been initiated.

14. The method of claim 8, wherein, when the fraud prevention response measure includes:
determining, using the computer processor, if an account of another customer was accessed by the ANI of the incoming call; and
determining if fraud was committed as a result.

15. A method for detecting fraud when receiving multiple calls from a caller to a call center of an enterprise, comprising:
determining, using a computer processor, if an automatic number identification (ANI) correlating to an incoming call to the call center is associated with more than three calls received by the call center within a current calendar day;
determining, using the computer processor, if one or more parameters are true:
the more than three calls received by the call center within the current calendar day inquired about accounts of more than three customers;
multiple calls per month to the call center relating to a customer account identified during the incoming call have been received for less than four months out of the last twelve months; and
an intent of the incoming call is associated with a possibility of fraud;
an authorization method provided by the incoming call is a weak authorization method;
a fraud alert has been generated in the last twelve months which is associated with the ANI of the incoming call or with the customer account;
a failed authorization attempt in the last twelve months is associated with the ANI of the incoming call or the customer account; and
the ANI of the incoming call is different from any phone numbers associated with the customer account; and
initiating, using the computer processor, a response measure when the ANI related to the incoming call to the call center is associated with more than three calls received by the call center within the current calendar day;
wherein:
the response measure is a fraud prevention response measure when at least three of the parameters are true;
the response measure is a customer service response measure when less than three of the parameters are true;
the response measure is provided in real time;
the intent associated with the possibility of fraud is a reporting a damaged credit card or requesting to change an address associated with the customer account identified during the incoming call; and
the weak authorization method provided is a postal code.

16. The method of claim 15, wherein the real time response measure is initiated during the incoming call.

17. The method of claim 15, wherein the real time response measure is initiated within the same calendar day as receipt of the incoming call.

18. The method of claim 15, wherein the fraud prevention response measure is to cancel a credit card associated with the customer account, reissue a new credit card to an address associated with first customer account, and transmit a notification containing a fraud alert against the ANI, the customer account, or both the ANI and the customer account to an organization which is administering the call center.

19. The method of claim 15, wherein the customer service response measure is to transfer the incoming call into a higher position in a queue to speak with a customer service representative than the incoming call would have received had the customer service response measure not been initiated.

20. The method of claim 15, wherein, when the fraud prevention response measure includes:
determining, using the computer processor, if an account of another customer was accessed by the ANI of the incoming call; and
determining if fraud was committed as a result.
